(19) United States
(12) Patent Application Publication
(10) Pub. No.: US 2008/0164713 A1
(43) Pub. Date: Jul. 10, 2008

(54) Vehicle personalization and protection panel

(76) Inventors: Terry C. Saurman, Converse, TX (US); Gloria Hinds, Schertz, TX (US)

Correspondence Address: John C. Cave, Suite 1500, 700 North St. Mary's Street, San Antonio, TX, 78205, US

(21) Appl. No.: 12/006,687

(22) Filed: Jan. 4, 2008

Related U.S. Application Data
(60) Provisional application No. 60/878,882, filed on Jan. 5, 2007.

(51) Int. Cl. B62D 25/00

(52) U.S. Cl. 296/77.1

(57) ABSTRACT

A personalization and protective panel for attachment to golf carts and other vehicles, trailers, etc. for protecting the passengers from the sun and flying debris, and providing a medium for easily removable personalization of a golf cart. Additionally, the present invention is portable, easily installed and removed, and attachable on a wide range of vehicles. The invention is comprised of a sheet of flexible, breathable, and durable material that is wrapped around frame members on the vehicle and held in place by a pair of grommet and hook-type stretch cord connectors.

### CROSS REFERENCE TO RELATED APPLICATIONS

This is an application claiming priority to provisional U.S. Patent Application Ser. No. 60/878,882 filed Jan. 5, 2007, entitled “Vehicle Personalization and Protection Panel,” which is incorporated by reference herein.

### BACKGROUND OF THE INVENTION

1. Technical Field

The present invention relates generally to portable panel for providing protection for vehicle passengers and decoration for the vehicle. More specifically, the present invention relates to an improved decorative panel that protects the passengers from the sun and flying debris by covering the area of a golf cart between the passengers and the golf club storage compartment on a golf cart behind the passengers' head.

There are a number of problems with the current design of golf cart covers and typical golf cart configurations. The typical golf cart does not provide protection from the sun or flying debris due to its open-air design. Additionally, many golf cart covers that are created to protect against the sun or flying debris are difficult to install and use, expensive and made of heavy or cumbersome materials that restrict air flow, and are simply more restrictive than necessary in moderate weather.

U.S. Pat. Nos. 6,869,125, 6,439,637, and 6,926,334 provide golf cart shields that protects from various weather conditions, but cover a much greater area of the cart, thereby restricting air flow. These apparatuses fail to allow as much air flow through the golf cart on hot days, are more difficult to install, are less portable, and are not conducive to visual personalization.

U.S. Pat. Nos. 6,773,052 and 6,547,312 provide protection from the elements for the storage compartment of the cart, however these devices are not intended to protect the passengers, hinder air flow through the cart, and are not easily removable.

As a result, it is preferable to provide an easily portable soft golf cart panel to provide shade, provide protection from flying debris and personalize the golf cart with decoration or advertisement without reducing air circulation for the passengers.

### OBJECT OF THE INVENTION

A primary object and feature of the present invention is to provide limited protection from the sun and flying debris to the occupants of a golf cart and other vehicles.

Additionally, it is an object and feature of the invention that the invention is composed of such material and dimensions as to minimize the reduction of the flow of air through the cart and other vehicles.

It is further an object and feature of the present invention to provide a medium to customize or personalize the golf cart or other vehicle in a temporary and easy to install manner, but without requiring damage or physical modification to the golf cart itself.

Additionally, it is an object and feature of the present invention to be able to be portable, easily stored, and carried inside a golf bag or other small container, if desired. It is also an object and feature of the present invention to be installed and removed from a cart or other vehicle in a very short amount of time, without modification or damage to the golf cart or vehicle.

A further object and feature of the present invention is to create a system that provides these features effectively in an inexpensive form, without complicated instructions or extensive time required to set up or remove. Additionally, it is an object and feature of the present invention for one embodiment of invention to be able to be used on a wide variety of golf carts and other vehicles without modification to the invention.

### BRIEF SUMMARY OF THE INVENTION

The above and other object and features are achieved though the use of a novel Vehicle Personalization and Protection Panel herein disclosed. In accordance with a preferred embodiment of the present invention, the Vehicle Personalization and Protection Panel as provided comprises a panel of durable, flexible netting and two connectors on one side of the sheet for attaching the invention to the frame of a golf cart. Preferably, the sheet of netting will be both dense enough to allow the image on the netting to be visible, but without significantly reducing the air flow through the netting. Preferably, the two connectors are stretch cord hook connectors affixed to the sheet in the hem on the top and bottom of one side of the netting. In addition, the sheet preferably has two grommets on the side of the sheet opposite the two stretch cord hook connectors, by which the sheet and stretch cords can be wrapped around the bars on the back of the golf cart which support the cart roof, and attached to the grommets at opposite ends of the frame of said cart.

It is to be understood that the invention is not limited in its application to these details and construction, the arrangement of components stated herein or in the drawings, or strictly the uses described. The invention is capable of different embodiments and being practiced in other ways. Also, the terms used here are for descriptive purposes only, and should not be regarded as limiting. As such, those skilled in the art will appreciate that the conception upon which this disclosure is based may easily be applied as a basis for designing other structures or methods for carrying out the listed purposes of the invention. Therefore, the invention is not limited to the exact embodiment herein illustrated and described, and accordingly, all appropriate modifications and equivalents may fall within the scope of the invention.

### BRIEF DESCRIPTION OF THE DRAWINGS

FIG. 1 provides a rear view of a golf cart having a preferred embodiment of the Golf Cart Personalization and Protection Apparatus installed on the rear side of the cart.

FIG. 2 provides a rear view of the present invention when not installed on a cart, as shown in FIG. 1.

FIG. 3 provides a top view of the present invention when installed on the cart as in FIG. 1 according to the present invention, where the stretch cords and netting are wrapped around the rear bars on the golf cart and are connected to the corresponding grommets.

FIG. 4 provides an enlarged perspective view of one of the stretch cord connectors and how it is affixed to the netting as in FIG. 2 as described in the preferred embodiment.

FIG. 5 provides an enlarged perspective view of one of the grommets from FIG. 2 and FIG. 3 as described in the preferred embodiment.

### DETAILED DESCRIPTION OF THE INVENTION

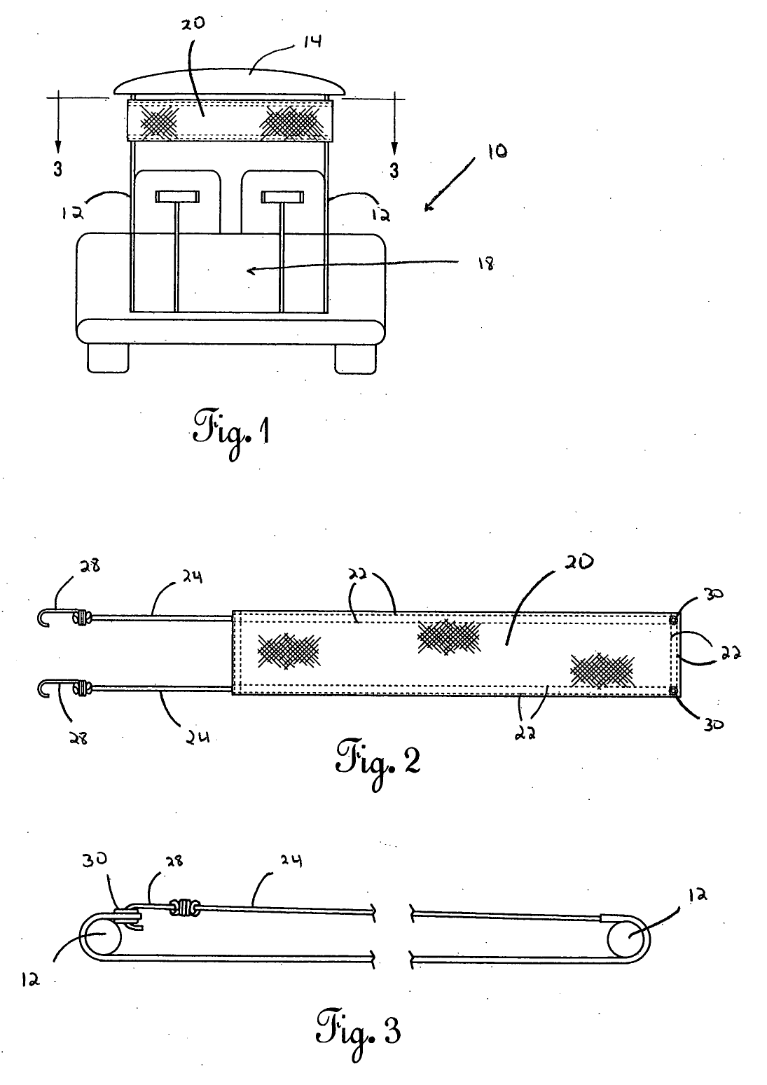

A preferred embodiment of the present invention is illustrated in the perspective view of FIG. 1 which discloses a golf cart 10 having a frame with vertical rear support bars 12 supporting the golf cart roof 14. The rear support bars 12 are positioned between the golf cart's seats 16 and golf club storage compartment 18. A panel 20 is affixed across the rear support bars 12 between the seats 10 and the roof 14 of the golf cart 10.

FIG. 2 shows preferred embodiment of the present invention when not attached to a golf cart, as in FIG. 1. The present invention as shown in FIG. 2 discloses a panel 20 comprised of flexible and durable material of sufficient thickness to withstand weather and strong winds. Said panel 20 may be composed of polyethylene netting, or other strong, durable, and all-weather material. It is also preferable that the material is susceptible to printing so that pictures, figures or words may be printed on the material. In the preferred embodiment, the panel 20 is cut to the proper size, and the edges are folded over and affixed with stitching 22 for additional durability. Stretch cords 24 are attached at the top and bottom of one end 26 of the panel 20. Hooks 28 are connected to the distal end of each stretch cord 24 and grommets 30 are installed in the panel 20 at the top and bottom of its other end 32.

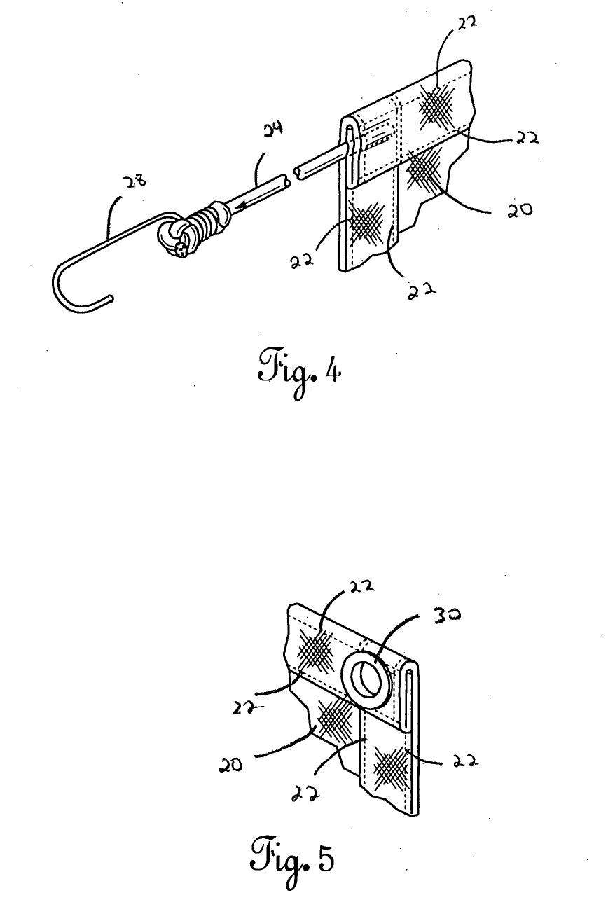

FIG. 3 is a top view depicting the panel 20 affixed to the rear support bars 12 of the golf cart 10. The panel 20 is stretched horizontally across the rear support bars 12 with the panel 20 being placed on the storage compartment side of the posts as shown in FIG. 1. The vertical edges of the panel 20 are wrapped around the support bars 12 and the panel 20 is held in place by pulling the stretch cords 24 and hooks 28 toward the grommets 30 and inserting the hooks 28 into the grommets 30. Preferably, when connected as shown in FIG. 1 and FIG. 3, the stretch cords will have enough tension to hold the panel 20 in place even in strong winds or when hit with flying debris. Preferably, the stretch cords 24 will be of such a type and elasticity that they will be able to accommodate a large variety of golf cart designs, such that the same design of the panel will be able to fit different widths of the bars as shown in FIG. 1 and FIG. 3 without modification to the invention's design. The stretch cords 24 and hooks 28 are well known in the art and can be any of a variety of bungee-type cords available. FIG. 4 depicts a cylindrical cord. However, it is anticipated that a flat stretchable strap may also be used.

FIG. 4 shows an enlargement of the stretch cord 24 and hook 28 and how it is affixed to the panel 20. Preferably, the stretch cord 24 is affixed to the panel 20 underneath the folded edge and affixed by some method, preferably nylon stitching. Alternatively, the stretch cord 24 or could be replaced with grommets, and a pair of non-attached stretch cords with hooks at both ends could be used to attach the panel 20 to the golf cart 10. In this alternative embodiment, the hooks would insert into the grommets at both ends.

FIG. 5 shows an enlargement of the grommet, and how it is affixed to the panel 20. Preferably, the grommet is affixed to the panel 20 by placement into the folded edge of the panel 20.

When the panel 20 is affixed to the golf cart 10, it can act as a shield from the sun's rays or for flying debris (such as golf balls) directed at passengers in the golf cart from the rear. It is also anticipated that the panel 20 will act as a canvass for pictures, figures, logos, or words for personalization of the golf cart and advertisement. For example, a university logo could be placed on the panel 20.

Although the preferred embodiment of the invention has been described as being affixed to a golf cart, the invention is not intended to be limited to a fixation only to golf carts. It is anticipated that the panel 20 is adaptable to be affixed to many types of vehicles to include tractors, trailers, four-wheelers, etc.

It is to be understood that the inventions are not limited to the exact construction or method illustrated, but that various changes and/or modifications may be made without departing from the spirit or scope of the inventions as more fully described in this Application.

We claim:

1. A portable panel for attachment to at least one vertical member comprising:
a rectangular, flexible fabric panel;
two flexible, elastic cords having first and second ends, said first ends of said cords attached to a first vertical side of said panel;
hooks attached to said second ends of each of said cords; and
openings in said panel adjacent a second vertical side of said panel for connection with said hooks.

2. The portable panel as recited in claim 1 further comprising of grommets reinforcing said openings.

3. The portable panel as recited in claim 1 wherein said fabric panel is made of netted material.

4. The portable panel as recited in claim 3 wherein said netted material is susceptible to printing on said material.

5. The portable panel as recited in claim 3 wherein said netted material is susceptible to sewing such that other fabric material may be sewed onto said netted material.

6. The portable panel as recited in claim 1 wherein said fabric panel and said cords are of sufficient strength to withstand small flying debris without tearing or detaching.

7. The portable panel as recited in claim 1 wherein said rectangular panel is square.

8. The portable panel as recited in claim 1 wherein said cords are made of woven material.

9. The portable panel as received in claim 1 wherein said cords are rubber straps.

10. A portable panel for attachment to at least one vertical member of a vehicle comprising:
a rectangular, flexible fabric panel;
two flexible, elastic cords having first and second ends, said first ends of said cords attached to a first vertical side of said panel;
hooks attached to said second ends of each of said cords; and
openings in said panel adjacent a second vertical side of said panel for connection with said hooks.

11. The portable panel as recited in claim 10 further comprising of grommets reinforcing said openings.

12. The portable panel as recited in claim 10 wherein said fabric panel is made of netted material.

13. The portable panel as recited in claim 12 wherein said netted material is susceptible to printing on said material.

14. The portable panel as recited in claim 12 wherein said netted material is susceptible to sewing such that other fabric material may be sewed onto said netted material.

15. The portable panel as recited in claim 10 wherein said fabric panel is of sufficient strength to withstand small flying debris.

16. The panel as recited in claim 10 wherein said vehicle is a golf cart.

17. The panel as recited in claim 16 wherein said at least one vertical member is two rear support bars supporting the roof of said golf cart.

18. The panel as recited in claim 17 wherein said panel is of sufficient length to fully extend between said rear support bars.

19. The panel as recited in claim 17 wherein said cords have sufficient elasticity to fully extend between said rear support bars of said golf cart when stretched.

20. The portable panel as recited in claim 10 wherein said rectangular panel is square.

21. The portable panel as recited in claim 10 wherein said cords are made of woven material.

22. The portable panel as received in claim 10 wherein said cords are rubber straps.
